(19) United States
(12) Patent Application Publication
(10) Pub. No.: US 2025/0285476 A1
(43) Pub. Date: Sep. 11, 2025

(54) DETERMINATION DEVICE, INFORMATION TRANSMISSION DEVICE, AND DETERMINATION SYSTEM

(71) Applicants: TOYOTA JIDOSHA KABUSHIKI KAISHA, Toyota-shi (JP); ADVICS CO., LTD., Kariya-shi (JP)

(72) Inventors: Yoshihisa YAMADA, Nagoya-shi (JP); Tomoya TANAKA, Kariya-shi (JP); Yasufumi ENAMI, Kariya-shi (JP)

(73) Assignees: TOYOTA JIDOSHA KABUSHIKI KAISHA, Toyota-shi (JP); ADVICS CO., LTD., Kariya-shi (JP)

(21) Appl. No.: 19/041,227

(22) Filed: Jan. 30, 2025

(30) Foreign Application Priority Data
Mar. 6, 2024 (JP) 2024-033759

(51) Int. Cl. G07C 5/04; G01M 17/013

(52) U.S. Cl. CPC G07C 5/04; G01M 17/013

(57) ABSTRACT

A determination device acquires fluctuation data indicating a progression of a fluctuation value that is a difference between a pre-process wheel speed detected by a wheel speed sensor that detects a rotation speed of a wheel of a vehicle, and a post-process wheel speed obtained by performing a low-pass filter process on the pre-process wheel speed. The determination device determines whether there is an anomaly in the wheel based on the fluctuation data.

### CROSS-REFERENCE TO RELATED APPLICATIONS

This application is based upon and claims the benefit of priority from Japanese Patent Application No. 2024-033759, filed on Mar. 6, 2024, the entire contents of which are incorporated herein by reference.

### BACKGROUND

### 1. Field

The present disclosure relates to a determination device, an information transmission device, and a determination system.

### 2. Description of Related Art

Japanese Patent No. 6526818 discloses a determination device. This determination device determines an anomaly in a wheel using the rotation speed of the wheel.

Anomalies in a wheel affect the traveling of the vehicle. It is desirable to determine an anomaly in a wheel before it significantly affects the traveling of the vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first general aspect, a determination device includes processing circuitry. The processing circuitry is configured to acquire fluctuation data indicating a progression of a fluctuation value that is a difference between a pre-process wheel speed detected by a wheel speed sensor that detects a rotation speed of a wheel of a vehicle and a post-process wheel speed obtained by performing a low-pass filter process on the pre-process wheel speed. The processing circuitry is also configured to determine whether there is an anomaly in the wheel based on the fluctuation data.

In a second general aspect, an information transmission device includes processing circuitry. The processing circuitry is configured to acquire a pre-process wheel speed detected by a wheel speed sensor that detects a rotation speed of a wheel of a vehicle, acquire a post-process wheel speed by performing low-pass filter process on the pre-process wheel speed, calculate a fluctuation value that is a difference between the pre-process wheel speed and the post-process wheel speed, and transmit fluctuation data indicating a progression of the fluctuation value to the determination device according to the first general aspect.

In a third general aspect, a determination system includes an information transmission device and a determination device. The information transmission device is configured to acquire a pre-process wheel speed detected by a wheel speed sensor that detects a rotation speed of a wheel of a vehicle, acquire a post-process wheel speed by performing low-pass filter process on the pre-process wheel speed, calculate a fluctuation value that is a difference between the pre-process wheel speed and the post-process wheel speed, and transmit fluctuation data indicating a progression of the fluctuation value to the determination device. The determination device is configured to determine whether there is an anomaly in the wheel based on the fluctuation data. The determination device is also configured to, when determining that there is an anomaly in the wheel, notify a user of the vehicle of the anomaly in the wheel.

Other features and aspects will be apparent from the following detailed description, the drawings, and the claims.

### BRIEF DESCRIPTION OF THE DRAWINGS

FIG. 1 is a schematic diagram illustrating a configuration of a determination system according to an embodiment.

FIG. 2 is a sequence diagram showing a manner of communication in the determination system shown in FIG. 1.

FIG. 3 is a graph showing an example of the progression of a pre-process wheel speed when there is no looseness in the fastening between a wheel and a hub.

FIG. 4 is a graph showing an example of the progression of a pre-process wheel speed when there is looseness in the fastening between a wheel and a hub.

FIG. 5 is a graph showing an example of the progression of a pre-process wheel speed in a case in which the vehicle travels on a road surface with significant irregularities.

FIG. 6 is a graph showing an example of the progression of a pre-process wheel speed and a post-process wheel speed.

FIG. 7 is a graph showing an example of the progression of a fluctuation amount when there is no looseness in the fastening between a wheel and a hub.

FIG. 8 is a graph showing an example of the progression of a fluctuation amount when there is looseness in the fastening between a wheel and a hub.

FIG. 9 is a graph showing an example of the progression when an upper limit value is set for the fluctuation amount in a case in which there is no looseness in the fastening between a wheel and a hub.

FIG. 10 is a graph showing an example of the progression when an upper limit value is set for the fluctuation amount in a case in which there is looseness in the fastening between a wheel and a hub.

FIG. 11 is a graph showing an example of the progression of a cumulative total of a time-integrated value over a specified period of the fluctuation amount.

FIG. 12 is a sequence diagram showing a manner of communication in a determination system according to a first modification.

FIG. 13 is a graph showing an example of the progression of a cumulative total of a time-integrated value before and after the fastening between a wheel and a hub is loosened.

FIG. 14 is a table showing past gradients stored for determining a threshold in a determination system according to a second modification.

FIG. 15 is a graph showing an example of the progression of a cumulative total of a time-integrated value for each of a wheel with no looseness in the fastening to a hub and a wheel with looseness in the fastening to a hub, among the wheels of a vehicle.

FIG. 16 is a graph showing the relationship between a prescribed range and an example of the progression of a fluctuation amount when there is no looseness in the fastening between a wheel and a hub.

FIG. 17 is a graph showing the relationship between a prescribed range and an example of the progression of a fluctuation amount when there is looseness in the fastening between a wheel and a hub.

FIG. 18 is a sequence diagram showing a manner of communication in a determination system according to a fourth modification.

FIG. 19 is a graph showing the progression of a convergence count in a determination system according to a fifth modification.

FIG. 20 is a table showing past gradients stored for determining a threshold in a determination system according to the fifth modification.

FIG. 21 is a graph showing an example of the progression of a convergence count for each of a wheel with no looseness in the fastening to a hub and a wheel with looseness in the fastening to a hub, among the wheels of a vehicle.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

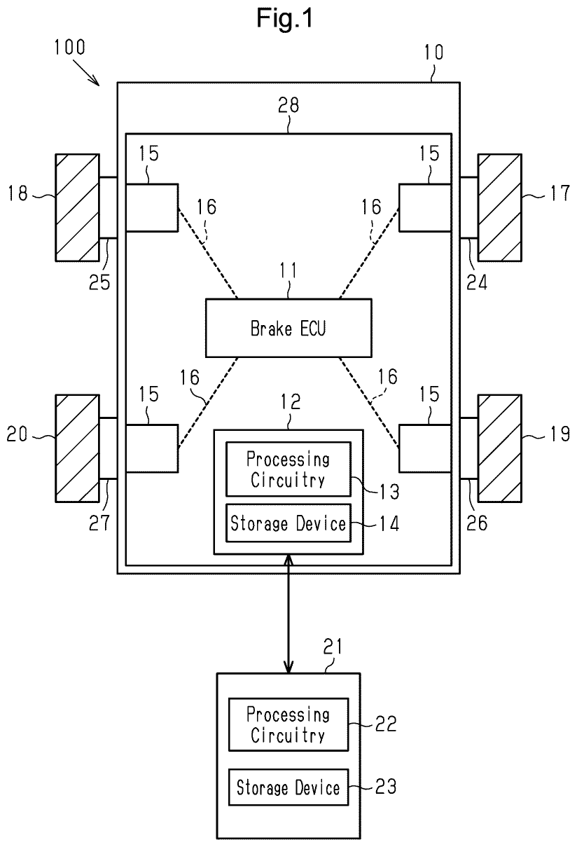

A determination system 100 according to an embodiment will now be described with reference to FIGS. 1 to 11.

### Configuration of Determination System 100

As shown in FIG. 1, the determination system 100 includes an information transmission device 28 mounted on a vehicle 10 and a determination device 21. The determination device 21 is, for example, a server installed outside the vehicle 10. The determination device 21 may be mounted on the vehicle 10.

The vehicle 10 includes information transmission device 28 and four wheels, which are a front-right (FR) wheel 17, a front-left (FL) wheel 18, a rear-right (RR) wheel 19, and a rear-left (RL) wheel 20. The FR wheel 17 is disposed at the front right side of the vehicle 10. The FL wheel 18 is disposed at the front left side of the vehicle 10. The RR wheel 19 is disposed at the rear right side of the vehicle 10. The RL wheel 20 is disposed at the rear left side of the vehicle 10.

As shown in FIG. 1, each wheel of the vehicle 10 is fastened to a corresponding hub. The FR wheel 17 is fastened to a front-right (FR) hub 24. The FL wheel 18 is fastened to a front-left (FL) hub 25. The RR wheel 19 is fastened to a rear-right (RR) hub 26. The RL wheel 20 is fastened to a rear-left (RL) hub 27.

As shown in FIG. 1, the information transmission device 28 includes multiple electronic control units (ECUs) and multiple wheel speed sensors 15. The information transmission device 28 includes a brake ECU 11 and a central ECU 12 as electronic control units.

As shown in FIG. 1, the central ECU 12 includes a storage device 14, which stores programs, and processing circuitry 13, which executes the programs stored in the storage device 14 to execute various processes. The processing circuitry 13 includes a processor. The central ECU 12 is connected to the brake ECU 11 in a manner allowing for communication.

As shown in FIG. 1, four wheel speed sensors 15 are installed in the vehicle 10 so as to correspond to the FR wheel 17, the FL wheel 18, the RR wheel 19, and the RL wheel 20, respectively. As shown in FIG. 1, each wheel speed sensor 15 is directly connected to the brake ECU 11 via a communication line 16.

Each of the wheel speed sensors 15 detects the rotation speed of the corresponding wheel. Each of the wheel speed sensors 15 transmits the detected rotation speed to the brake ECU 11 through the communication line 16 as a pre-process wheel speed. In this way, the brake ECU 11 acquires the pre-process wheel speeds detected by the wheel speed sensors 15.

As shown in FIG. 1, the determination device 21 includes a storage device 23, which stores programs, and processing circuitry 22, which executes the programs stored in the storage device 23 to execute various processes. The processing circuitry 22 includes a processor.

Each of the processing circuitry 13 and the processing circuitry 22 may include one or more dedicated hardware circuits such as an application-specific integrated circuit (ASIC) that executes at least a part of various processes. Alternatively, each of the processing circuitry 13 and the processing circuitry 22 may include a combination of one or more processors and one or more dedicated hardware circuits. Each processor may include a CPU and a memory module such as a RAM and a ROM. The memory module stores program codes or instructions configured to cause the CPU to execute processes. The memory module, namely, a computer-readable medium, includes any available medium that is accessible by a general-purpose or special-purpose computer.

The determination device 21 is connected to the information transmission device 28 in a manner allowing for communication. The determination device 21 may be connected to the information transmission device 28 in a wired or wireless manner, for example. The determination device 21 is connected to the central ECU 12 in a manner allowing for communication.

The determination device 21 determines whether there is an anomaly in one or more wheels of the vehicle 10 based on the information received from the information transmission device 28. The determination device 21 determines whether there is any looseness in the fastening between any of the wheels and the corresponding hub, and categorizes the looseness as a wheel anomaly.

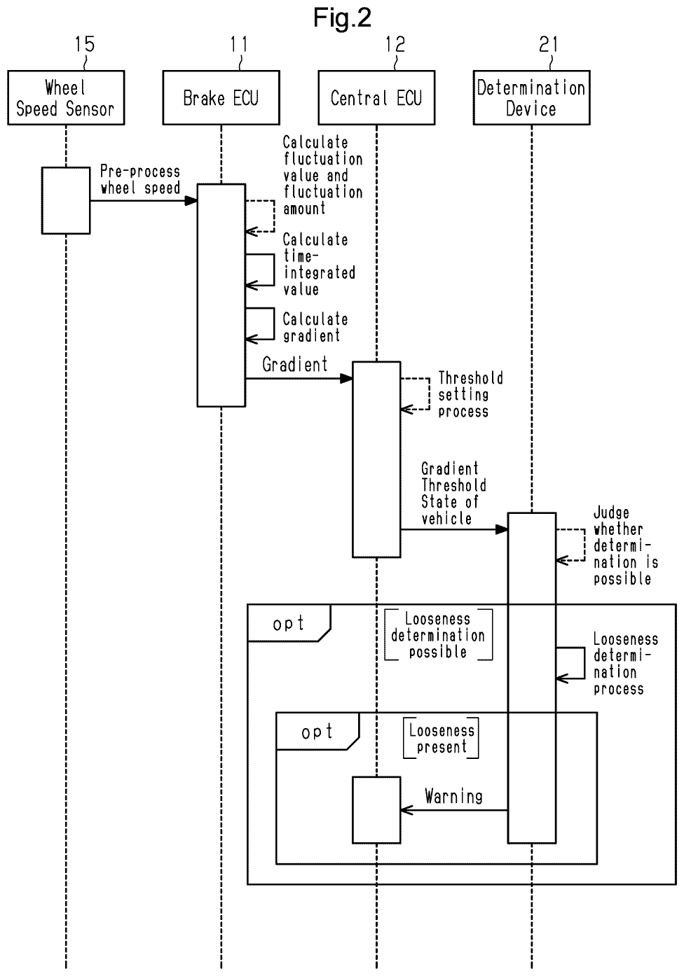

FIG. 2 shows a manner of communication performed among the brake ECU 11, the central ECU 12, the wheel speed sensor 15, and the determination device 21. In FIG. 2, the processes executed by the central ECU 12 are executed by the processing circuitry 13. In FIG. 2, the processes executed by the determination device 21 are executed by the processing circuitry 22.

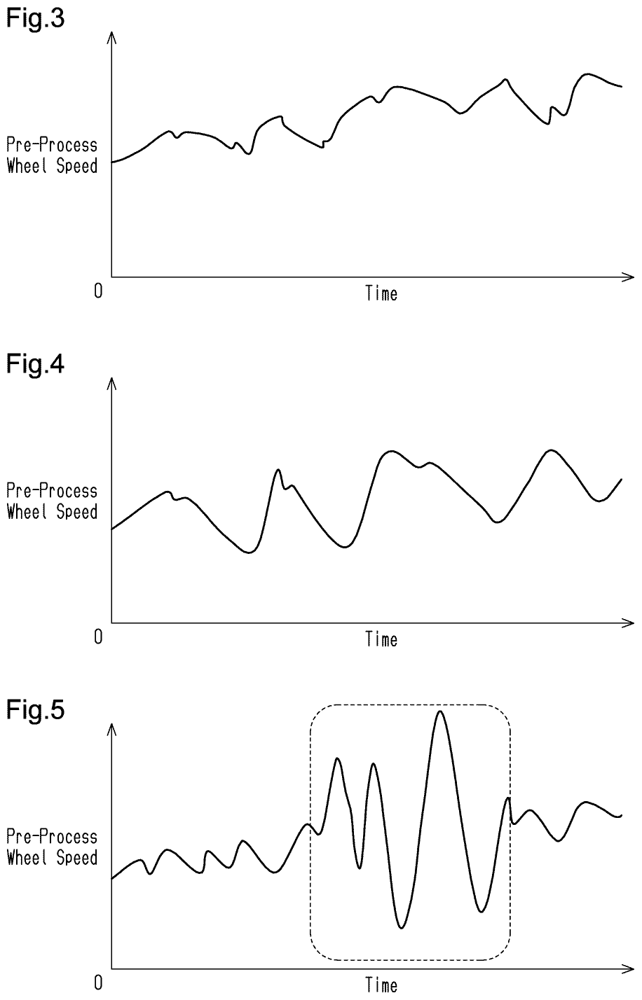

Hereinafter, the sequence diagram of FIG. 2 will be described with reference to FIGS. 3 to 11.

### Outline of Pre-Process Wheel Speed

As shown in the upper section of FIG. 2, the wheel speed sensor 15 transmits the pre-process wheel speed to the brake ECU 11. Hereinafter, the characteristics of the pre-process wheel speed will be described with reference to FIGS. 3 to 5.

FIG. 3 shows an example of the progression of a pre-process wheel speed when there is no looseness in the fastening between the wheel and the hub. The graph shown in FIG. 3 represents, for example, the pre-process wheel speed of the FR wheel 17 detected by the corresponding wheel speed sensor 15.

In the graph of FIG. 3, the vertical axis represents the pre-process wheel speed. In the graph of FIG. 3, the horizontal axis represents time. The same applies to the vertical axes and the horizontal axes of the graphs in FIGS. 4 and 5.

The pre-process wheel speed fluctuates finely due to factors such as minor irregularities on the road surface and the tread pattern of the wheel. Accordingly, as shown in FIG. 3, the pre-process wheel speed fluctuates finely over time.

FIG. 4 shows an example of the progression of a pre-process wheel speed when there is looseness in the fastening between the wheel and the hub. The graph shown in FIG. 4 represents, for example, the pre-process wheel speed of the FR wheel 17 detected by the corresponding wheel speed sensor 15 when the bolts for fastening the FR wheel 17 and the FR hub 24 together are loosened by one rotation, for example. The pre-process wheel speed shown in FIG. 4 is detected under the same conditions as when the pre-process wheel speed shown in FIG. 3 was detected, except that the bolts are loosened. In other words, the pre-process wheel speed shown in FIG. 4 is the wheel speed detected when the vehicle 10 travels at the same speed at the same location where the pre-process wheel speed shown in FIG. 3 was detected.

When comparing FIGS. 3 and 4 with each other, the amplitude of the graph in FIG. 4 is greater than the amplitude of the graph in FIG. 3. In other words, the amount of change in the pre-process wheel speed when there is looseness in the fastening between the wheel and the hub is greater than the amount of change in the pre-process wheel speed when there is no looseness.

FIG. 5 shows an example of the progression of ae pre-process wheel speed with no looseness in the fastening between the wheel and the hub in a case in which the vehicle 10 travels on a road surface with larger irregularities than those in the case of FIG. 3. The graph shown in FIG. 5 represents the pre-process wheel speed of the FR wheel 17 detected by the wheel speed sensor 15, for example, when the vehicle 10 travels on a road surface with larger irregularities than those on the road surface on which the pre-process wheel speed shown in FIG. 3 was detected. The pre-process wheel speed shown in FIG. 5 is detected under the same conditions as when the pre-process wheel speed shown in FIG. 3 was detected, except that the irregularities on the road surface are larger. In other words, the pre-process wheel speed shown in FIG. 5 is detected when the vehicle 10 travels at the same speed as the speed at which the pre-process wheel speed shown in FIG. 3 was detected.

In FIG. 5, a portion surrounded by the dotted line reflects the pre-process wheel speed when the vehicle 10 travels on a road surface with larger irregularities than those on the road surface in the case of FIG. 3. In portions not surrounded by the dotted line in FIG. 5, the vehicle 10 travels on a road surface with irregularities of substantially the same size as those on the road surface on which the vehicle 10 traveled in the case of FIG. 3.

As shown in FIG. 5, the amplitude of the graph in the portions not surrounded by the dotted line is substantially the same as the amplitude of the graph in FIG. 3. In contrast, in FIG. 5, the amplitude of the graph in the portion surrounded by the dotted line is greater than the amplitude of the graph in FIG. 3. That is, even when there is no looseness in the fastening between the wheel and the hub, the amount of change in the pre-process wheel speed increases as the irregularities of the road surface become larger.

As described with reference to FIG. 3, the pre-process wheel speed fluctuates finely due to factors such as minor irregularities on the road surface and the tread pattern of the wheel. As described with reference to FIG. 4, the amount of change in the pre-process wheel speed is greater when there is looseness in the fastening between the wheel and the hub than when there is no looseness. On the other hand, as described with reference to FIG. 5, even if there is no looseness in the fastening between the wheel and the hub, the amount of change in the pre-process wheel speed is greater when the irregularities on the road surface are relatively large than when the irregularities are relatively small.

As described with reference to FIG. 2, each wheel speed sensor 15 transmits the pre-process wheel speed having such characteristics to the brake ECU 11.

Outline of Fluctuation Value and Fluctuation Amount Calculated in Determination System 100

As shown in the upper section of FIG. 2, the brake ECU 11, upon receiving the pre-process wheel speed, calculates a fluctuation value and a fluctuation amount from the received pre-process wheel speed.

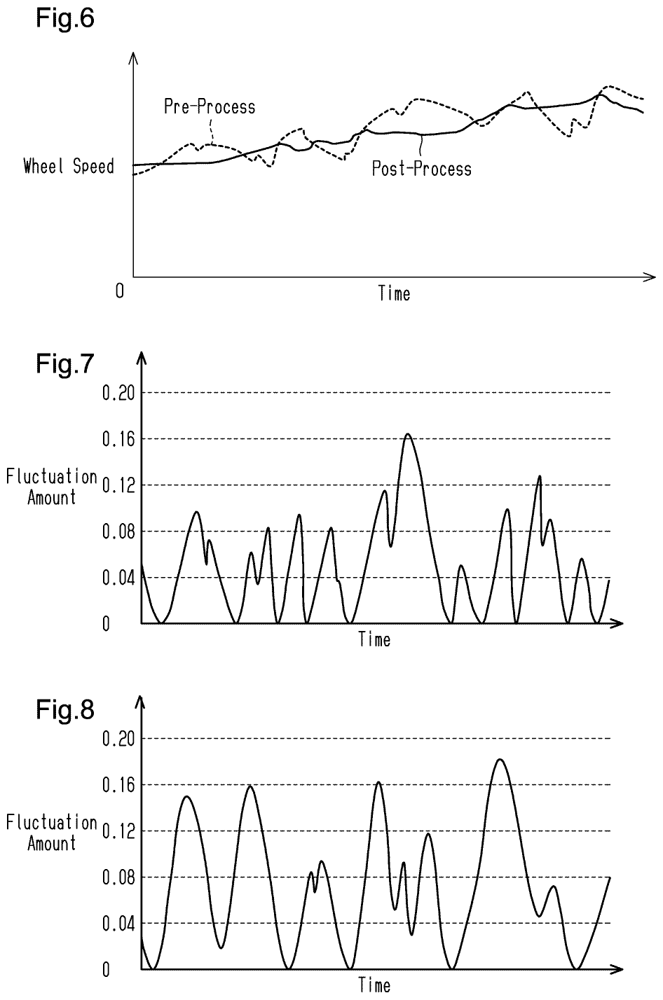

The fluctuation value and the fluctuation amount will now be described with reference to FIGS. 6 to 8.

FIG. 6 shows an example of the progressions of a pre-process wheel speed and a post-process wheel speed, which is calculated based on the pre-process wheel speed. In FIG. 6, the dotted line is the same as the line of the pre-process wheel speed shown in FIG. 3. On the other hand, in FIG. 6, the solid line represents the progression of the post-process wheel speed, which is calculated based on the pre-process wheel speed in FIG. 3. In FIG. 6, the horizontal axis represents time as in FIG. 3.

The post-process wheel speed is a value obtained by performing a low-pass filter process on the pre-process wheel speed. The post-process wheel speed shown in FIG. 6 represents a value obtained by applying a low-pass filter process of 2 Hz to the pre-process wheel speed shown in FIG. 3. The value of the filter used in the low-pass filter process is not limited to 2 Hz.

Fine fluctuations in the pre-process wheel speed are removed from the post-process wheel speed obtained by performing the low-pass filter process on the pre-process wheel speed. In other words, the post-process wheel speed reflects the general trend of the pre-process wheel speed. Accordingly, as shown in FIG. 6, the pre-process wheel speed moves up and down around the post-process wheel speed.

In the upper section of FIG. 2, the brake ECU 11 calculates the fluctuation value and the fluctuation amount from the pre-process wheel speed and the post-process wheel speed as shown in FIG. 6.

The fluctuation value indicates the difference between the pre-process wheel speed and the post-process wheel speed. In other words, the fluctuation value indicates fine fluctuations in the pre-process wheel speed.

The fluctuation amount is the absolute value of the fluctuation value. FIGS. 7 and 8 are graphs showing examples of the progression of the fluctuation amount. In FIGS. 7 and 8, the horizontal axes represent time as in FIG. 3.

Specifically, FIG. 7 shows the progression of the fluctuation amount obtained by converting the fluctuation value, which is the difference between the pre-process wheel speed and the post-process wheel speed shown in FIG. 6, into an absolute value. At a point in time where the fluctuation amount is relatively large in FIG. 7, the deviation between the solid line and the dotted line in FIG. 6 is also relatively large. In contrast, at a point in time where the fluctuation amount is zero in FIG. 7, the solid line and the dotted line in FIG. 6 intersect with each other

The fluctuation amount shown in FIG. 7 is calculated based on the pre-process wheel speed shown in FIG. 3. In other words, the fluctuation amount shown in FIG. 7 represents an example of the progression of the fluctuation amount when there is no looseness in the fastening between the wheel and the hub.

FIG. 8 shows the progression of the fluctuation amount calculated based on the pre-process wheel speed shown in FIG. 4. In other words, the fluctuation amount shown in FIG. 8 represents an example of the progression of the fluctuation amount when there is looseness in the fastening between the wheel and the hub.

As can be seen from the comparison between FIGS. 7 and 8, the amplitude of the graph of the fluctuation amount shown in FIG. 8 tends to be greater than the amplitude of the graph of the fluctuation amount shown in FIG. 7. In this manner, the fluctuation amount is greater when there is looseness in the fastening between the wheel and the hub than when there is no looseness.

The determination device 21 determines whether there is looseness in the fastening between the wheel and the hub based on the progression of the fluctuation value by using such characteristics of the fluctuation amount. As described above, the fluctuation value represents fine fluctuations in the pre-process wheel speed. By using the progression of the fluctuation value, the determination device 21 is capable of detecting the occurrence of looseness in the fastening between the wheel and the hub at the onset of a change in the fluctuation amount.

As shown in the upper section of FIG. 2, the brake ECU 11 calculates the fluctuation value and the fluctuation amount based on the pre-process wheel speed received from the wheel speed sensor 15. The determination device 21 determines whether there is an anomaly in the wheel based on the progression of the fluctuation value calculated by the brake ECU 11, which is directly connected to the wheel speed sensor 15. The brake ECU 11 is directly connected to the wheel speed sensor 15 via the communication line 16, and is thus capable of acquiring the pre-process wheel speed with high resolution. As a result, the brake ECU 11 is capable of calculating precise fluctuation values.

### Outline of Time-Integrated Value Calculated in Determination System 100

As shown in the upper section of FIG. 2, the brake ECU 11, upon calculating the fluctuation value and the fluctuation amount, calculates a time-integrated value over a prescribed period of the fluctuation amount. The brake ECU 11 periodically calculates the time-integrated value.

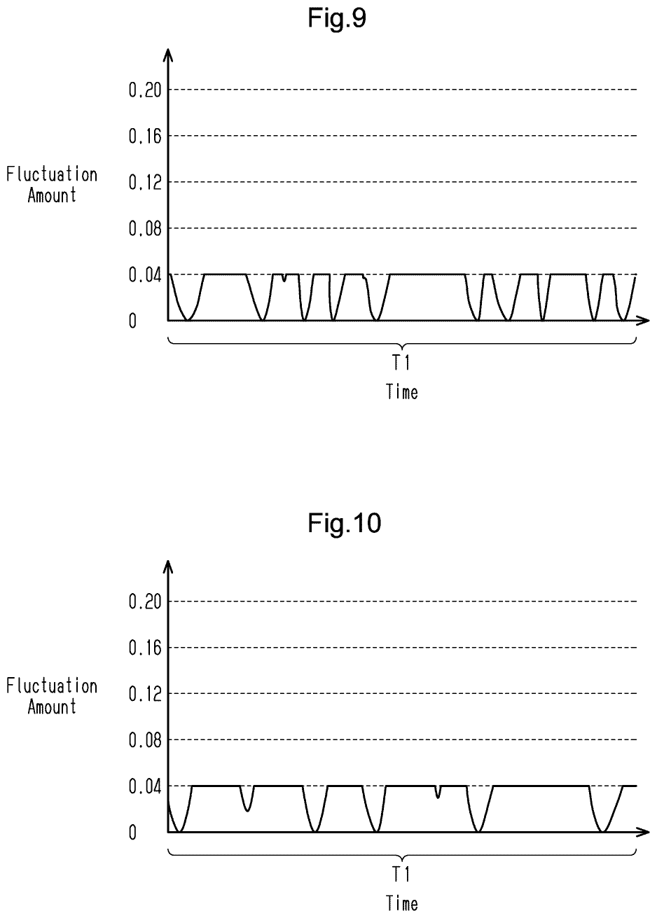

Hereinafter, the time-integrated value will be described with reference to FIGS. 9 and 10.

The time-integrated value over the prescribed period of the fluctuation amount in a case in which there is looseness in the fastening between the wheel and the hub is greater than that in a case in which there is no looseness. This is because the fluctuation amount is larger when there is looseness in the fastening between the wheel and the hub than when there is no looseness.

As described with reference to FIG. 5, even if there is no looseness in the fastening between the wheel and the hub, the amount of change in the pre-process wheel speed is greater when the irregularities on the road surface are relatively large than when the irregularities are relatively small. For example, when the vehicle 10 passes over a large bump, the amplitude of the fluctuation value may increase instantaneously. When such an instantaneous event occurs, a large amplitude in the fluctuation amount leads to increases in the time-integrated value of the fluctuation amount. Such an instantaneous event may cause the determination device 21 to erroneously determine that there is looseness in the fastening between the wheel and the hub. In this regard, an upper limit value is set for the fluctuation amount, which is used by the determination device 21 to calculate the time-integrated value.

FIG. 9 illustrates the fluctuation amount with an upper limit that is referenced in the determination system 100 when calculating the time-integrated value from the fluctuation amount shown in FIG. 7. As shown in FIG. 9, the upper limit of the fluctuation amount is 0.04. The upper limit value is not limited to 0.04. The fluctuation amount exceeding the upper limit value is replaced with a value equal to the upper limit value. The upper limit value is a cutoff value for defining the upper limit of the fluctuation amount.

The upper limit value set in the determination system 100 is set in consideration of the characteristics of the vehicle 10. The characteristics of the vehicle 10 are features of the vehicle 10 that affect the fluctuation value. The characteristics of the vehicle 10 are, for example, the size and weight of the wheels of the vehicle 10. The characteristics of the vehicle 10 may be, for example, the weight of the vehicle 10 or the vibration transmissibility of the suspensions of the vehicle 10.

For example, when the characteristics of the vehicle 10 are likely to reduce the fluctuation amount, the upper limit value is set to be relatively low. The upper limit value may be set in advance in accordance with the characteristics of the vehicle 10. The upper limit value may be calculated based on the history of the progression of the past fluctuation amount.

The determination device 21 determines whether there is looseness between the wheel and the hub based on the time-integrated value over the prescribed period of the fluctuation amount shown in FIG. 9. The time-integrated value of the fluctuation amount is calculated, for example, using a period T1 shown in FIG. 9 as the prescribed period. In this manner, the time-integrated value used by the determination device 21 to perform determination is calculated using a fluctuation amount that is limited to an upper limit value so as not to exceed the upper limit value.

FIG. 10 illustrates the fluctuation amount with an upper limit that is referenced in the determination system 100 when calculating the time-integrated value from the fluctuation amount shown in FIG. 8. In FIG. 10, the time-integrated value of the fluctuation amount is calculated using the period T1 period as the prescribed period, as in the case shown in FIG. 9.

The time-integrated value of the fluctuation amount with the upper limit value shown in FIG. 10 is greater than the time-integrated value of the fluctuation amount with the upper limit value shown in FIG. 9. Thus, even in the case in which the upper limit value is defined for the fluctuation amount, the time-integrated value of the fluctuation amount in a case in which there is looseness in the fastening between the wheel and the hub is larger than that in a case in which there is no looseness.

As shown in the upper section of FIG. 2, the brake ECU 11 periodically calculates the time-integrated value from the fluctuation amount. The determination device 21 determines whether there is looseness in the fastening between the wheel and the hub using the time-integrated value over the prescribed period of the fluctuation amount. As described above, the pre-process wheel speed can fluctuate significantly and instantaneously due to external factors such as road surface irregularities. The determination device 21 is capable of accurately performing the determination by using the time-integrated value, which is a value obtained by aggregating the information of the magnitude of the fluctuation amount over the prescribed period.

### Outline of Gradient Calculated in Determination System 100

As shown in the upper section of FIG. 2, after calculating the time-integrated value, the brake ECU 11 calculates a gradient related to the calculated time-integrated value.

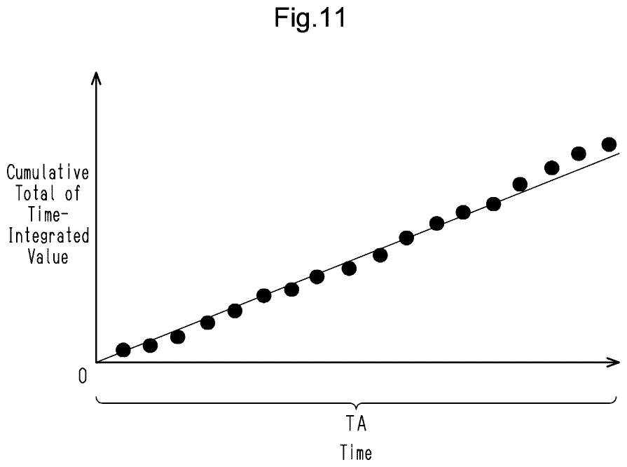

The gradient will now be described with reference to FIG. 11.

FIG. 11 illustrates an example of the progression in the cumulative total of the time-integrated value calculated in the determination system 100.

As described above, the time-integrated value is calculated periodically. The brake ECU 11 calculates the time-integrated value each time the prescribed period elapses. Points shown in FIG. 11 represent values of the cumulative total of the time-integrated values calculated by the brake ECU 11 for each prescribed period. Accordingly, the value represented by each point in FIG. 11 is the sum of the value represented by the preceding point and a newly calculated time-integrated value.

As shown in FIG. 11, the brake ECU 11 accumulates the time-integrated values calculated for each prescribed period. The brake ECU 11 uses multiple time-integrated values calculated in a calculation period that is longer than the prescribed period to calculate the gradient of the progression of the cumulative total of the time-integrated values in the calculation period. In the present embodiment, the calculation period is represented by TA in FIG. 11.

The brake ECU 11 calculates the gradient from the values of the cumulative total of the time-integrated values calculated during the calculation period. The straight line shown in FIG. 11 is a regression line for the progression of the cumulative total of the time-integrated values. The brake ECU 11 calculates the gradient of the regression line as the gradient of the progression of the cumulative total of the time-integrated values in the calculation period. The determination device 21 determines whether there is looseness in the fastening between the wheel and the hub based on the gradient calculated in this manner.

As described above, the time-integrated value over the prescribed period of the fluctuation amount in a case in which there is looseness in the fastening between the wheel and the hub is greater than that in a case in which there is no looseness. Therefore, the gradient of the progression of the cumulative total of the time-integrated values in the calculation period is greater in a case in which there is looseness than in a case in which there is no looseness.

Based on this characteristic, the determination device 21 is capable of determining that there is looseness in the fastening between the wheel and the hub when judging that the gradient calculated by the brake ECU 11 is greater than the gradient in a normal condition. As shown in the upper section of FIG. 2, the brake ECU 11, upon calculating the gradient, transmits the calculated gradient to the central ECU 12.

Manner in which Central ECU 12 Performs Processes

With reference to FIG. 2, the following describes a manner in which the central ECU 12 and the determination device 21 communicate with each other in order for the determination device 21 to determine whether there is looseness in the fastening between the wheel and the hub based on the gradient.

As shown in the middle section of FIG. 2, the central ECU 12, upon receiving the gradient, executes a threshold setting process. As will be described later, the determination device 21 determines whether there is looseness in the fastening between the wheel and the hub by comparing the threshold and the gradient. The central ECU 12 sets the threshold to be used by the determination device 21 in the threshold setting process.

The central ECU 12 stores a reference threshold, for example, in the storage device 14 in advance. In the threshold setting process, the central ECU 12 sets the threshold by adjusting the reference threshold stored in the storage device 14 based on the characteristics of the vehicle 10. Instead of storing a reference threshold in the storage device 14 in advance, the central ECU 12 may calculate a reference threshold based on the history of the past gradients in the vehicle 10.

In the threshold setting process, the central ECU 12 sets the threshold in consideration of the characteristics of the vehicle 10. For example, when the characteristics of the vehicle 10 are likely to increase the fluctuation amount, the threshold is set to a relatively high value.

The central ECU 12 may set a common threshold for the FR wheel 17, the FL wheel 18, the RR wheel 19, and the RL wheel 20 in the threshold setting process. In the threshold setting process, the central ECU 12 may set different thresholds for the FR wheel 17, the FL wheel 18, the RR wheel 19, and the RL wheel 20.

As shown in the middle section of FIG. 2, the central ECU 12, upon executing the threshold setting process, transmits the gradient received from the brake ECU 11 to the determination device 21. As shown in the middle section of FIG. 2, the central ECU 12 transmits the threshold set in the threshold setting process to the determination device 21.

As shown in the middle section of FIG. 2, the central ECU 12 transmits information indicating the state of the vehicle 10 when transmitting the gradient. The state of the vehicle 10 is information relating to the traveling state of the vehicle 10 in the calculation period for the gradient transmitted to the determination device 21.

The central ECU 12 transmits, as the information indicating the state of the vehicle 10, the information of the features that were activated during the calculation period. For example, if the vehicle 10 activated the antilock brake system, the central ECU 12 transmits information indicating that the antilock brake system was activated as the information indicating the state of the vehicle 10. If the vehicle 10 activated the traction control system, the central ECU 12 transmits information indicating that the traction control system was activated as the information indicating the state of the vehicle 10. If the vehicle 10 activated the vehicle stability control system, the central ECU 12 transmits information indicating that the vehicle stability control system was activated as the information indicating the state of the vehicle 10.

The central ECU 12 transmits, as information indicating the state of the vehicle 10, information indicating that the vehicle 10 was traveling on rough terrain during the calculation period. At this time, the central ECU 12 judges that the vehicle 10 is traveling on rough terrain, for example, from information of a camera mounted on the vehicle 10. For example, the central ECU 12 may judge that the vehicle 10 is traveling on rough terrain based on changes in the traveling speed of the vehicle 10.

The information transmission device 28 acquires the pre-process wheel speed detected by the wheel speed sensor 15. Then, the information transmission device 28 calculates the fluctuation value. The fluctuation value is the difference between the acquired pre-process wheel speed and the post-process wheel speed, which is obtained by performing the low-pass filter process on the pre-process wheel speed. Thereafter, the information transmission device 28 transmits the fluctuation data indicating the progression of the calculated fluctuation value to the determination device 21.

The information transmission device 28 periodically calculates the time-integrated value over the prescribed period of the fluctuation amount, which is the absolute value of the fluctuation value. Thereafter, the information transmission device 28 uses multiple time-integrated values calculated in the calculation period, which is longer than the prescribed period, to calculate the gradient of the progression of the cumulative total of the time-integrated values in the calculation period. Then, the information transmission device 28 transmits the calculated gradient to the determination device 21 as fluctuation data.

Manner in which Determination Device 21 Performs Processes

As shown in the lower section of FIG. 2, after receiving the gradient, the threshold, and the information indicating the state of the vehicle 10 from the central ECU 12, the determination device 21 judges whether it is possible to determine whether there is looseness in the fastening between the wheel and the hub.

In the judgement of whether the determination is possible, the determination device 21 checks the received information indicating the state of the vehicle 10.

For example, when the vehicle 10 is not in a normal traveling state, such as when the vehicle 10 is rapidly decelerating, the pre-process wheel speed detected by the wheel speed sensor 15 is also not normal. If the determination device 21 calculates the fluctuation value under such an abnormal condition and then uses this fluctuation value as the basis for the determination, the determination device 21 cannot perform the determination accurately.

When the vehicle 10 is rapidly decelerating, the vehicle 10 activates the antilock brake system. In this manner, an activated feature of the vehicle 10 may reflect the fact that the vehicle 10 is not in a normal traveling state. The determination device 21 does not determine whether there is looseness in the fastening between the wheel and the hub when the vehicle 10 is activating a feature that is activated when the vehicle 10 is not in a normal traveling state. For example, the determination device 21 does not determine whether there is looseness in the fastening between the wheel and the hub when the information indicating the state of the vehicle 10 indicates that the vehicle 10 is activating the antilock brake system, the traction control system, the vehicle stability control system, or the like.

As described above, the determination device 21 does not use, for the determination of whether there is an anomaly in the wheel, the progression of the fluctuation value that is calculated based on the pre-process wheel speed detected by the wheel speed sensor 15 while the vehicle 10 is activating the antilock brake system. Also, the determination device 21 does not use, for the determination of whether there is an anomaly in the wheel, the progression of the fluctuation value that is calculated based on the pre-process wheel speed detected by the wheel speed sensor 15 while the vehicle 10 is activating the traction control system. Further, the determination device 21 does not use, for the determination of whether there is an anomaly in the wheel, the progression of the fluctuation value that is calculated based on the pre-process wheel speed detected by the wheel speed sensor 15 while the vehicle 10 is activating the vehicle stability control system.

As described above, even if there is no looseness in the fastening between the wheel and the hub, the amount of change in the pre-process wheel speed is greater when the irregularities on the road surface are relatively large than when the irregularities are relatively small. Therefore, the determination device 21 cannot accurately perform the determination on rough terrain with relatively large irregularities.

The determination device 21 does not determine whether there is looseness in the fastening between the wheel and the hub when the determination device 21 receives information indicating that the vehicle 10 is traveling on rough terrain as the information indicating the state of the vehicle 10. In other words, the determination device 21 does not use, for the determination of whether there is an anomaly in the wheel, the progression of the fluctuation value calculated based on the pre-process wheel speed detected by the wheel speed sensor 15 while the vehicle 10 is traveling on rough terrain.

As shown in the lower section of FIG. 2, when judging that it is possible to determine whether there is looseness in the fastening between the wheel and the hub, the determination device 21 executes a looseness determination process. In the looseness determination process, the determination device 21 compares the gradient received from the central ECU 12 with the threshold. When the gradient is greater than or equal to the threshold, the determination device 21 determines that the wheel, for which the pre-process wheel speed used for the calculation of the gradient is detected, is loosely fastened to the hub.

As shown in the lower section of FIG. 2, when the determination device 21 determines that there is looseness in the fastening between any of the wheels and the corresponding hub of the vehicle 10, the determination device 21 transmits a warning to the central ECU 12. In the looseness determination process, the determination device 21 compares the gradient of each of the FR wheel 17, the FL wheel 18, the RR wheel 19, and the RL wheel 20 with the threshold. When determining that any of the FR wheel 17, the FL wheel 18, the RR wheel 19, and the RL wheel 20 is loosely fastened to the hub, the determination device 21 transmits a warning to the central ECU 12. The determination device 21 transmits, as a warning, information indicating that there is a possibility of looseness in the fastening between the wheel and the hub and information indicating the wheel determined to have looseness in the fastening to the hub. For example, the central ECU 12 displays a warning message on a display in the vehicle 10 based on the received information. In this manner, when determining that there is an anomaly in any of the wheels, the determination device 21 notifies the user of the vehicle 10 of the anomaly in the wheel.

### Operation of the Present Embodiment

The pre-process wheel speed fluctuates finely due to factors such as minor irregularities on the road surface and the tread pattern of the wheel. The post-process wheel speed, which is obtained by performing the low-pass filter process on the pre-process wheel speed, is a value from which such fine fluctuations are removed. In other words, the post-process wheel speed reflects the general trend of the pre-process wheel speed. When an anomaly occurs in the wheel, the fluctuation amount, which is the absolute value of the fluctuation value, increases. The determination device 21 is capable of detecting the occurrence of an anomaly at a stage where a change starts to appear in the fluctuation amount by using the progression of the fluctuation value, which indicates fine fluctuations of the pre-process wheel speed.

### Advantages of the Present Embodiment

(1) The above-described determination device 21 is capable of detecting anomalies in the wheels before the anomalies significantly affect the traveling.
(2) The determination device 21 determines whether there is any looseness in the fastening between any of the wheels and the corresponding hub, and categorizes the looseness as a wheel anomaly. When there is looseness in the fastening between the wheel and the hub, the fluctuation amount increases. Since the looseness gradually increases, the fluctuation amount gradually increases. The determination device 21 determines whether there is looseness by using the progression of the fluctuation value. Therefore, the determination device 21 is capable of detecting the occurrence of the looseness while the looseness is increasing, that is, at a stage before the traveling of the vehicle 10 is significantly affected.
(3) The determination device 21 determines whether there is looseness in the fastening between the wheel and the hub using the time-integrated value over the prescribed period of the fluctuation amount, which is the absolute value of the fluctuation value. The time-integrated value of the fluctuation amount is greater in a case in which there is looseness in the fastening between the wheel and the hub than in a case in which the wheel has no anomaly. The time-integrated value of the fluctuation amount is a value obtained by aggregating information on the magnitude of the fluctuation amount in the prescribed period. The pre-process wheel speed can fluctuate significantly and instantaneously due to external factors such as road surface irregularities. The determination device 21 determines whether there is looseness in the fastening between the wheel and the hub based on the time-integrated value of the fluctuation amount. As a result, the determination device 21 prevents an erroneous determination from being made based on instantaneous changes in the fluctuation value.
(4) An upper limit value is set for the fluctuation amount used to calculate the time-integrated value. The time-integrated value used by the determination device 21 is calculated using the fluctuation amount, which is limited by the upper limit value so as not to exceed the upper limit value.

For example, when the vehicle 10 passes over a large bump, the amplitude of the fluctuation value may increase instantaneously. When such an instantaneous event occurs, a large amplitude in the fluctuation amount leads to increases in the time-integrated value of the fluctuation amount. Therefore, when such an instantaneous event occurs, the determination device 21 may make an erroneous determination. The time-integrated value used by the determination device 21 to perform the determination is calculated using the fluctuation amount, which is limited by the upper limit value so as not to exceed the upper limit value. Accordingly, even if the amplitude of the fluctuation value increases instantaneously, the fluctuation amount limited by the upper limit value is reflected in the time-integrated value. This allows the determination device 21 to perform the determination highly accurately, while suppressing the influence of an instantaneous event on the determination.
(5) The time-integrated value is calculated periodically. The determination device 21 calculates the gradient of the progression of the cumulative total of the time-integrated value in the calculation period using the multiple values of time-integrated value calculated in the calculation period, which is longer than the prescribed period. The determination device 21 then determines whether there is looseness in the fastening between the wheel and the hub based on the calculated gradient.

When the vehicle 10 continues to travel in a state in which there is looseness in the fastening between any of the wheels and the corresponding hub, the looseness gradually increases. Accordingly, the time-integrated value of the fluctuation amount gradually increases. Therefore, when the looseness is increasing, a change appears in the gradient of the progression of the accumulation of the time-integrated value. The determination device 21 determines whether there is looseness between the wheel and the hub by using the gradient of the progression of the accumulation of the time-integrated value. The determination device 21 detects looseness while the looseness is increasing by monitoring changes appearing in the gradient.
(6) The determination device 21 determines that there is looseness in the fastening between the wheel and the hub when the gradient is greater than or equal to the threshold. The determination device 21 detects that the looseness is increasing based on the fact that the gradient is larger than the gradient of the normal time. As a result, the determination device 21 is capable of detecting the occurrence of looseness.
(7) The determination device 21 does not use, for the determination of whether there is an anomaly in the wheel, the progression of the fluctuation value that is calculated based on the pre-process wheel speed detected by the wheel speed sensor 15 while the vehicle 10 is activating the antilock brake system.

Depending on the traveling state of the vehicle 10, the determination device 21 may be unable to accurately determine whether there is an anomaly in any of the wheels, for example, when the vehicle 10 is rapidly decelerating. Therefore, when the determination device 21 determines whether there is an anomaly in any of the wheels, it is desirable that the vehicle 10 be in a normal traveling state.

When the vehicle 10 is rapidly decelerating, the vehicle 10 activates the antilock brake system. The determination device 21 does not determine whether there is an anomaly in any of the wheels when the vehicle 10 is activating the antilock brake system. The determination device 21 thus suppresses the occurrence of erroneous determination.
(8) The determination device 21 does not use, for the determination of whether there is an anomaly in the wheel, the progression of the fluctuation value that is calculated based on the pre-process wheel speed detected by the wheel speed sensor 15 while the vehicle 10 is activating the traction control system.

When the vehicle 10 is activating the traction control system, the vehicle 10 is not in a normal traveling state, and thus the determination device 21 cannot perform the determination accurately. The determination device 21 does not determine whether there is an anomaly in any of the wheels when the vehicle 10 is activating the traction control system. The determination device 21 thus suppresses the occurrence of erroneous determination.
(9) The determination device 21 does not use, for the determination of whether there is an anomaly in the wheel, the progression of the fluctuation value that is calculated based on the pre-process wheel speed detected by the wheel speed sensor 15 while the vehicle 10 is activating the vehicle stability control system.

When the vehicle 10 is activating the vehicle stability control system, the vehicle 10 is not in a normal traveling state, and thus the determination device 21 cannot perform the determination accurately. The determination device 21 does not determine whether there is an anomaly in any of the wheels when the vehicle 10 is activating the vehicle stability control system. The determination device 21 thus suppresses the occurrence of erroneous determination.
(10) The determination device 21 does not use, for the determination of whether there is an anomaly in the wheel, the progression of the fluctuation value calculated based on the pre-process wheel speed detected by the wheel speed sensor 15 while the vehicle 10 is traveling on rough terrain.

When the vehicle 10 is traveling on rough terrain, the determination device 21 cannot perform the determination accurately. The determination device 21 does not determine whether there is an anomaly in any of the wheels when the vehicle 10 is traveling on rough terrain. The determination device 21 thus suppresses the occurrence of erroneous determination.
(11) The vehicle 10 includes the brake ECU 11, which is an electronic control unit directly connected to the wheel speed sensors 15 via the communication lines 16. The determination device 21 determines whether there is an anomaly in any of the wheels based on the progression of the fluctuation value calculated by the brake ECU 11.

Since the brake ECU 11 is directly connected to each wheel speed sensor 15 via the corresponding communication line 16, it is possible to acquire the pre-process wheel speed with high resolution. As a result, the brake ECU 11 is capable of calculating accurate fluctuation values. The determination device 21 determines whether there is an anomaly in any of the wheels based on the fluctuation value calculated by the brake ECU 11. Thus, the determination device 21 performs determination with high accuracy.
(12) The information transmission device 28 acquires the pre-process wheel speed detected by the wheel speed sensor 15. The information transmission device 28 calculates the fluctuation value. The fluctuation value is the difference between the acquired pre-process wheel speed and the post-process wheel speed, which is obtained by performing the low-pass filter process on the pre-process wheel speed. The information transmission device 28 transmits the fluctuation data indicating the progression of the calculated fluctuation value to the determination device 21.

Thus, the information transmission device 28 causes the determination device 21 to determine whether there is an anomaly in the wheel.
(13) The information transmission device 28 periodically calculates the time-integrated value over the prescribed period of the fluctuation amount, which is the absolute value of the fluctuation value. The information transmission device 28 uses multiple time-integrated values calculated in the calculation period, which is longer than the prescribed period, to calculate the gradient of the progression of the cumulative total of the time-integrated values in the calculation period. The information transmission device 28 transmits the calculated gradient to the determination device 21 as fluctuation data.

Thus, the information transmission device 28 causes the determination device 21 to determine whether there is an anomaly in the wheel based on the gradient of the progression of the cumulative total of the time-integrated value.
(14) The determination system 100 includes the information transmission device 28 and the determination device 21. The information transmission device 28 acquires the pre-process wheel speed detected by the wheel speed sensor 15. The information transmission device 28 calculates the fluctuation value. The fluctuation value is the difference between the acquired pre-process wheel speed and the post-process wheel speed, which is obtained by performing the low-pass filter process on the pre-process wheel speed. The information transmission device 28 transmits the fluctuation data indicating the progression of the calculated fluctuation value to the determination device 21. The determination device 21 determines whether there is an anomaly in the wheel based on the received fluctuation data. When determining that there is an anomaly in the wheels, the determination device 21 notifies the user of the vehicle 10 of the anomaly in the wheel.

The determination system 100 determines whether there is an anomaly in the wheel by observing the progression of the fluctuation value. As a result, the determination system 100 notifies the user of the presence of an anomaly in the wheel before a significant influence is exerted on traveling.
(15) In the determination system 100, the determination device 21 determines whether there is any looseness in the fastening between any of the wheels and the corresponding hub, and categorizes the looseness as a wheel anomaly. This allows the determination system 100 to warn the user of the occurrence of looseness while the looseness is increasing, that is, at a stage before the traveling of the vehicle 10 is significantly affected.

### Modifications

The above-described embodiment may be modified as follows. The above-described embodiment and the following modifications can be combined as long as the combined modifications remain technically consistent with each other.

In the above-described embodiment, the determination device 21 determines looseness in the fastening between the wheel and the hub as an anomaly in the wheel. However, anomalies in the wheel determined by the determination device 21 are not limited to looseness in the fastening between the wheel and the hub. For example, the determination device 21 can detect that the air pressure in the wheel is not at an appropriate level as an anomaly in the wheel. For example, the determination device 21 can detect that one of the multiple wheels of the vehicle 10 is a studless tire.

In the above-described embodiment, the determination device 21 determines whether there is looseness in the fastening between each of the FR wheel 17, the FL wheel 18, the RR wheel 19, and the RL wheel 20 and the associated hub. The number of wheels for which the determination device 21 determines whether there is looseness is not limited to that in the above-described embodiment. For example, the determination device 21 may determine only whether there is looseness in the fastening between the FR wheel 17 and the FR hub 24. In this case, the information transmission device 28 does not need to include the wheel speed sensors 15 corresponding to wheels other than the FR wheel 17.

In the above-described embodiment, the brake ECU 11 is connected to the wheel speed sensors 15 through the communication lines 16, as described with reference to FIG. 1. However, the brake ECU 11 may be wirelessly connected to the wheel speed sensors 15.

In the above-described embodiment, the determination device 21 judges whether it is possible to perform the determination before executing the looseness determination process, as described with reference to FIG. 2. In the determination system 100, the information transmission device 28 may judge whether the determination is possible.

For example, the central ECU 12 in the information transmission device 28 judges whether the determination device 21 can execute the looseness determination process based on the information indicating the state of the vehicle 10. When the determination device 21 judges that the execution of the looseness determination process is impossible, the central ECU 12 does not transmit information such as the gradient to the determination device 21.

In the above-described embodiment, the determination device 21 judges whether it is possible to perform the determination before executing the looseness determination process, as described with reference to FIG. 2. The determination device 21 may always perform the determination without judging whether the determination is possible. In this case, the central ECU 12 does not need to transmit the information indicating the characteristics of the vehicle 10 in the middle section of FIG. 2.

In the above-described embodiment, the brake ECU 11 calculates the fluctuation value and the fluctuation amount as described with reference to FIG. 2. The fluctuation value and the fluctuation amount do not necessarily need to be calculated by the brake ECU 11. For example, the central ECU 12 may calculate the fluctuation value and the fluctuation amount from the pre-process wheel speed. Further, the determination device 21 may calculate the fluctuation value and the fluctuation amount from the pre-process wheel speed.

In the above-described embodiment, the brake ECU 11 calculates the time-integrated value as described with reference to FIG. 2. The time-integrated value does not necessarily need to be calculated by the brake ECU 11. For example, the central ECU 12 may calculate the time-integrated value from the fluctuation amount. For example, the determination device 21 may calculate the time-integrated value from the fluctuation amount.

In the above-described embodiment, the brake ECU 11 calculates the gradient as described with reference to FIG. 2. The gradient does not necessarily need to be calculated by the brake ECU 11. For example, the central ECU 12 may calculate the gradient from the time-integrated value. For example, the determination device 21 may calculate the gradient from the time-integrated value.

In the above-described embodiment, the central ECU 12 sets the threshold as described with reference to FIG. 2. The determination device 21 may set the threshold.

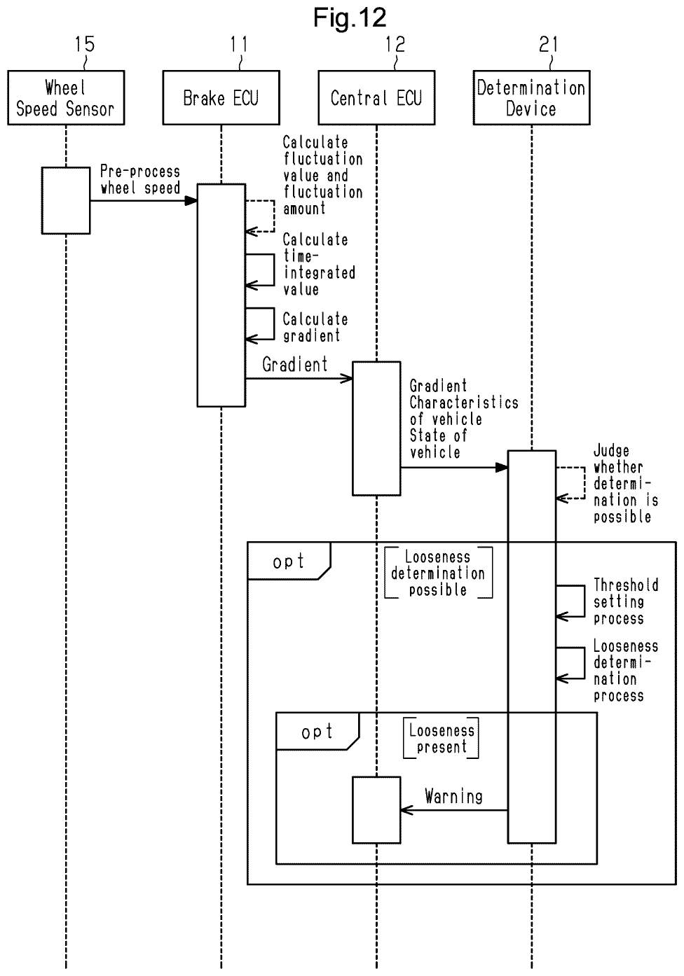

FIG. 12 shows a manner of communication in a determination system 100 according to a first modification, which performed among the brake ECU 11, the central ECU 12, the wheel speed sensor 15, and the determination device 21. In FIG. 12, the processes executed by the central ECU 12 are executed by the processing circuitry 13. In FIG. 12, the processes executed by the determination device 21 are executed by the processing circuitry 22.

In FIG. 12, the manner of communication from the transmission of the pre-process wheel speed by the wheel speed sensor 15 to the transmission of the gradient by the brake ECU 11 is the same as that in FIG. 2.

In the middle section of FIG. 12, the central ECU 12, upon receiving the gradient, transmits the received gradient, information indicating the characteristics of the vehicle 10, and information indicating the state of the vehicle 10 to the determination device 21. The determination device 21, upon receiving the information from the central ECU 12, judges whether it is possible to determine whether there is looseness in the fastening between the wheel and the hub. At this time, the process executed by the determination device 21 is the same as the process executed by the determination device 21 in the lower section of FIG. 2.

As shown in the lower section of FIG. 12, when judging that it is possible to determine whether there is looseness in the fastening between the wheel and the hub, the determination device 21 executes a threshold setting process. The determination device 21 stores a reference threshold, for example, in the storage device 23 in advance. In the threshold setting process, the determination device 21 sets the threshold by adjusting the reference threshold stored in the storage device 23 based on the characteristics of the vehicle 10. Instead of storing a reference threshold in the storage device 23 in advance, the determination device 21 may calculate a reference threshold based on the history of the past gradients in the vehicle 10.

The determination device 21 sets a common threshold for the FR wheel 17, the FL wheel 18, the RR wheel 19, and the RL wheel 20 in the threshold setting process. In the threshold setting process, the determination device 21 may set different thresholds for the FR wheel 17, the FL wheel 18, the RR wheel 19, and the RL wheel 20.

As shown in the lower section of FIG. 12, the determination device 21 executes the looseness determination process after executing the threshold setting process. In the looseness determination process, the determination device 21 compares the gradient received from the central ECU 12 with a threshold set by the determination device 21. When the gradient is greater than or equal to the threshold, the determination device 21 determines that the wheel, for which the pre-process wheel speed used for the calculation of the gradient is detected, is loosely fastened to the hub.

As shown in the lower section of FIG. 12, when the determination device 21 determines that there is looseness in the fastening between any of the wheels and the corresponding hub of the vehicle 10, the determination device 21 transmits a warning to the central ECU 12. The processes executed here are the same as the processes through which the determination device 21 transmits a warning to the central ECU 12 in the lower section of FIG. 2.

In the above-described embodiment, the central ECU 12 executes the threshold setting process, as described in the middle section of FIG. 2. In the threshold setting process, the central ECU 12 sets the threshold by adjusting the reference threshold. The central ECU 12 may set the threshold based on the history of the past gradients of the wheel for which the determination is performed.

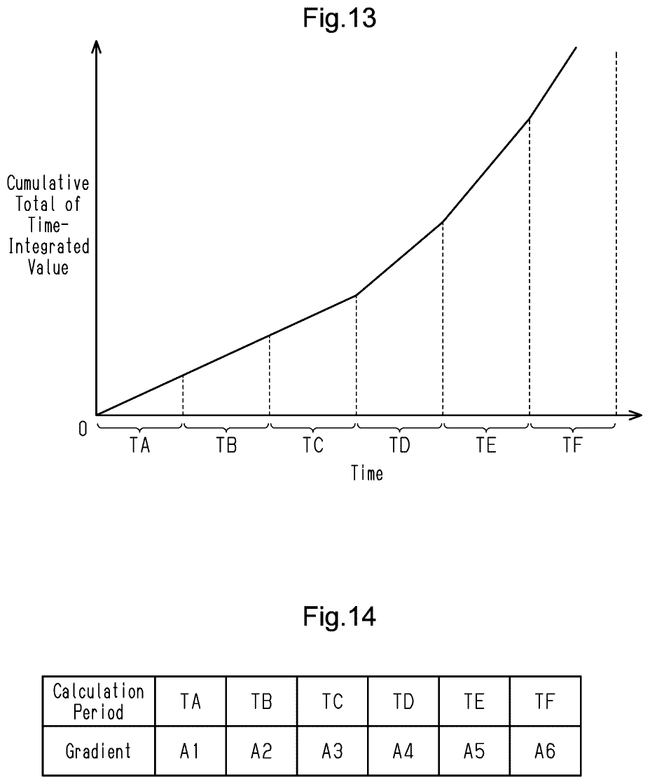

FIG. 13 illustrates an example of the progression in the cumulative total of time-integrated values calculated in the determination system 100 according to a second modification. In FIG. 13, the calculation period indicated by TA is the same as the calculation period indicated by TA in FIG. 11. In FIG. 13, each of periods TB, TC, TD, TE, and TF indicates a calculation period having the same length as the calculation period indicated by TA in FIG. 11. In FIG. 13, TA, TB, TC, TD, TE, and TF each indicate a calculation period.

The progression of the cumulative total of the time-integrated value shown in FIG. 13 is calculated from, for example, the pre-process wheel speed detected at the FR wheel 17. In FIG. 13, the looseness in the fastening between the FR wheel 17 and the FR hub 24 starts increasing in the middle of the period TD.

As shown in FIG. 13, the gradient calculated from the time-integrated value in the FR wheel 17 starts increasing in the period TD. The gradient calculated from the time-integrated value at the FR wheel 17 gradually increases after the period TD. This is because when the vehicle 10 continues to travel in a state in which there is looseness in the fastening between any of the wheels and the corresponding hub, the looseness gradually increases. Accordingly, the time-integrated value of the fluctuation amount gradually increases. In this manner, the gradient calculated from the time-integrated value at the wheel increases as the looseness increases from the time when the looseness occurs.

The determination device 21 determines that looseness has occurred in the fastening between the wheel for which the determination is performed and the hub when the gradient calculated from the time-integrated value at that wheel is larger than the past gradient of the wheel.

FIG. 14 shows data stored in the storage device 14 of the determination system 100 according to the second modification. The data is used by the central ECU 12 to set a threshold. As shown in FIG. 14, the central ECU 12 stores, in the storage device 14, the gradients calculated from the time-integrated values of the wheel for which the determination is performed, in association with each calculation period.

In FIG. 14, the gradient in the time period TA in FIG. 13 is A1. In FIG. 14, the gradients calculated in the respective calculation periods in FIG. 13 are represented by signs A1, A2, and A3. In the determination system 100 of the second modification, when performing the determination for each of the FR wheel 17, the FL wheel 18, the RR wheel 19, and the RL wheel 20, the central ECU 12 stores the gradient for each wheel.

As described with reference to the upper section of FIG. 2, the brake ECU 11 transmits the calculated gradients to the central ECU 12. The central ECU 12 sets the threshold by using a moving average of the received gradients. The central ECU 12 stores the newest three of the gradients received from the brake ECU 11. The central ECU 12 then sets the threshold based on the three stored gradients. For example, the central ECU 12 may set the threshold to be greater than the average of the three stored gradients.

Hereinafter, an example will be described. A case will now be discussed in which the central ECU 12 receives the gradient in the period TD from the brake ECU 11 when the gradients in the periods TA, TB, and TC shown in FIG. 14 are already stored. At this time, the central ECU 12 sets the threshold to a value greater than the average of A1, A2, and A3 in FIG. 14 in the threshold setting process shown in FIG. 2. Thereafter, the central ECU 12 discards the gradient A1 in the period TA, and newly stores the gradient A4 in the period TD in the storage device 14. In this manner, the central ECU 12 sets the threshold based on the stored gradients, while updating the gradients stored in the storage device 14.

The number of gradients stored in the central ECU 12 is not limited to the number described in the second modification. The manner in which the central ECU 12 sets the threshold based on the past gradients is not limited to the manner in which the threshold is set to a value greater than the average of the stored gradients.

In the second modification, the central ECU 12 sets the threshold. As in the first modification, the threshold may be set by the determination device 21. In this case, the determination device 21 sets the threshold based on the gradients stored in the storage device 23.

In this manner, the determination device 21 determines whether there is looseness in the fastening between the wheel for which the determination is performed and the hub by using the threshold set based on the past gradients of that wheel.

In this case, the determination device 21 uses, as the threshold, a value set based on the past gradients of the wheel, for which the determination is performed. As the looseness increases, the gradient of the time-integrated value increases. The determination device 21 detects that the looseness is increasing based on the data obtained from the wheel for which the determination is performed. As a result, the determination device 21 detects the occurrence of the looseness of the wheel.

In the above-described embodiment, the central ECU 12 executes the threshold setting process, as described in the middle section of FIG. 2. In the threshold setting process, the central ECU 12 sets the threshold by adjusting the reference threshold. The central ECU 12 may set the threshold based on the gradient of the time-integrated value at a wheel for which the determination is not performed, among the multiple wheels of the vehicle 10.

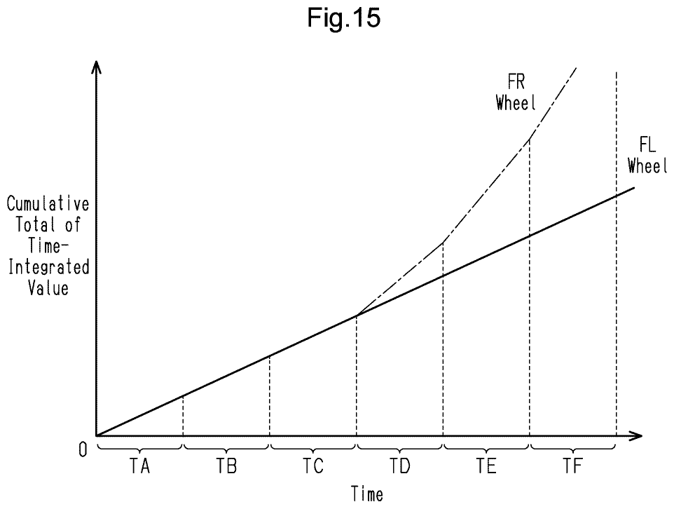

FIG. 15 illustrates an example of the progression in the cumulative total of time-integrated values calculated in the determination system 100 according to a third modification. In FIG. 15, the period TA is the same as the period TA shown in FIG. 11. In FIG. 15, the periods TB, TC, TD, TE, and TF are the same as the period TA shown in FIG. 11. In FIG. 15, TA, TB, TC, TD, TE, and TF each indicate a calculation period.

FIG. 15 collectively shows the progressions of the time-integrated values at the FR wheel 17 and the FL wheel 18. In FIG. 15, the looseness in the fastening between the FR wheel 17 and the FR hub 24 starts increasing in the middle of the period TD, as in the case shown in FIG. 13.

As shown in FIG. 15, the gradient of the FR wheel 17 before the period TD is the same as the gradient of the FL wheel 18 in the same time period. The factors that affect the pre-process wheel speed include a factor that uniformly affects the pre-process wheel speeds of all the wheels of the vehicle 10. For example, a change in the road surface condition uniformly affects the pre-process wheel speeds of all the wheels of the same vehicle. Therefore, while there is no factor affecting the pre-process wheel speed of a specific wheel in the vehicle 10, the gradient of the FR wheel 17 is substantially the same as the gradients of the other wheels in the same time period.

As shown in FIG. 15, the gradient calculated from the time-integrated value in the FR wheel 17 starts after the period TD. The gradient of the FR wheel 17 from the time period TD is larger than the gradient of the FL wheel 18 in each of the same time periods. In this manner, when one of the multiple wheels of the same vehicle is loosened from the hub, the gradient of the loosened wheel is greater than the gradients of the other wheels.

The determination device 21 determines that looseness has occurred in the fastening between the wheel for which the determination is performed and the hub when the gradient calculated for that wheel is larger than the gradients of the other wheels in the same time period.

The determination system 100 according to the third modification performs the processes described below.

In the determination system 100 of the third modification, the central ECU 12 acquires the gradients of the FR wheel 17, the FL wheel 18, the RR wheel 19, and the RL wheel 20 in the same time period. As described with reference to the upper section of FIG. 2, the brake ECU 11 transmits the calculated gradients to the central ECU 12. In the third modification, the central ECU 12 starts executing the threshold setting process when the gradients of the FR wheel 17, the FL wheel 18, the RR wheel 19, and the RL wheel 20 are aligned during the same time period.

In the threshold setting process, the central ECU 12 calculates the average of the gradients in the same time period at the wheels for which the determination is not performed, among the multiple wheels of the vehicle 10. For example, when setting the threshold used in the determination for the FR wheel 17, the central ECU 12 calculates an average value of the gradients of the FL wheel 18, the RR wheel 19, and the RL wheel 20 in the same time period. Then, the central ECU 12 sets the threshold based on the calculated average value. For example, the central ECU 12 sets the threshold corresponding to the FR wheel 17 to a value greater than the calculated average value.

The manner in which the central ECU 12 sets the threshold based on the gradients of the wheels for which the determination is not performed among the multiple wheels of the vehicle 10 is not limited to the manner according to the third modification. For example, the central ECU 12 may set the threshold corresponding to the FR wheel 17 to a value greater than the gradient of the FL wheel 18 in the same time period.

In the third modification, the central ECU 12 sets the threshold. As in the first modification, the threshold may be set by the determination device 21. In this case, the determination device 21 acquires information on the gradients of the wheels from the brake ECU 11.

In this manner, the determination device 21 determines whether there is looseness in the fastening between any of the wheels and the hub by using the threshold that is set based on the gradients in the same time period at the wheels for which the determination is not performed, among the wheels of the vehicle 10.

In this case, the determination device 21 uses, as the threshold, a value set based on the gradients in the same time period at wheels for which the determination is not performed among the multiple wheels of the vehicle 10. When any one of the multiple wheels is loosened from the hub, the gradient of the loosened wheel is greater than the gradients of the other wheels. The factors that affect the pre-process wheel speed include a factor that uniformly affects the pre-process wheel speeds of all the wheels of the vehicle, like a change in the road surface condition. The determination device 21 determines whether there is looseness by comparing the gradients of the wheels of the same vehicle. The determination device 21 thus suppresses the occurrence of erroneous determination due to a factor that uniformly affects the pre-process wheel speeds of all the wheels.

In the above-described embodiment, the determination device 21 determines whether there is looseness in the fastening between the wheel and the hub based on the gradient related to the time-integrated value calculated from the fluctuation amount at the wheel. In order for the determination device 21 to determine whether there is looseness in the fastening between the wheel and the hub, the time-integrated value and the gradient do not necessarily have to be calculated. For example, the determination device 21 may determine whether there is looseness in the fastening between the wheel and the hub based on a convergence count of the fluctuation value.

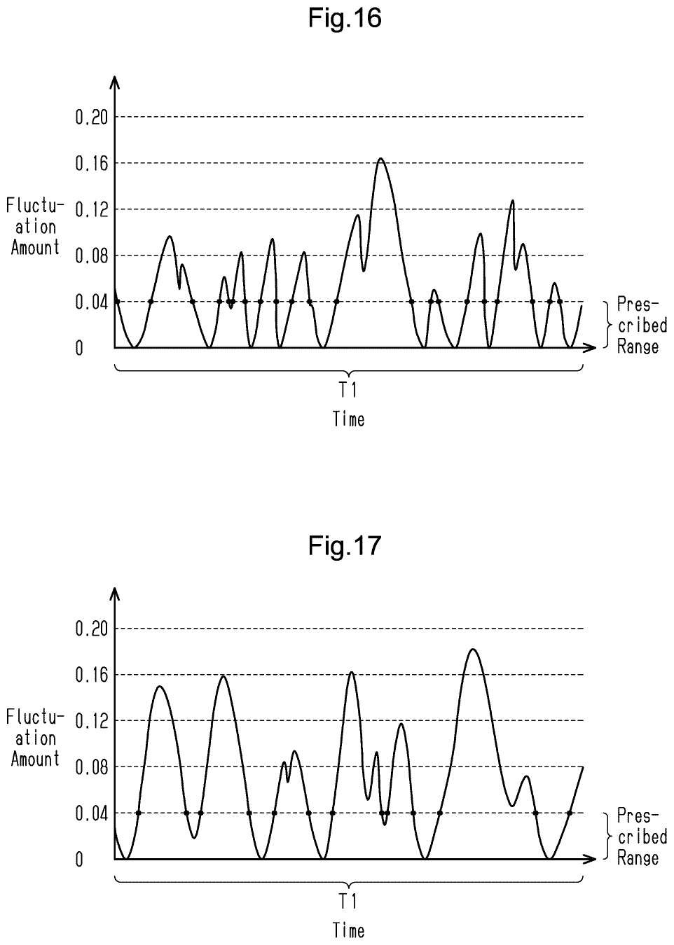

The convergence count will now be described with reference to FIGS. 16 and 17.

FIG. 16 is the same graph as the progression of the fluctuation amount shown in FIG. 7. In other words, the fluctuation amount shown in FIG. 16 represents an example of the progression of the fluctuation amount when there is no looseness in the fastening between the wheel and the hub.

A prescribed range is set for the progression of the fluctuation amount shown in FIG. 16. The prescribed range refers to a range centered around zero, defined for the fluctuation value. FIG. 16 shows the fluctuation amount, which represents the absolute value of the fluctuation, and thus shows the prescribed range in correspondence with the fluctuation amount.

In FIG. 16, the limit value of the prescribed range is 0.04. The limit value of the prescribed range is set in consideration of the characteristics of the vehicle 10. For example, when the characteristics of the vehicle 10 are likely to reduce the fluctuation amount, the upper limit value of the prescribed range is set to be low. The upper limit value of the prescribed range may be set in advance in accordance with the characteristics of the vehicle 10. In addition, the upper limit value of the prescribed range may be calculated based on the history of the progression of the past fluctuation amount.

The configuration of the prescribed range is not limited to the manner shown in FIG. 16. The limit value of the prescribed range is not limited to 0.04. In FIG. 16, the prescribed range is set for the fluctuation amount, which is the absolute value of the fluctuation value. However, the determination system 100 can set the prescribed range for the fluctuation value, for example, by setting two values 0.04 and −0.04 as the limit values of the prescribed range.

The convergence count refers to the sum of the number of times the fluctuation value has changed from outside the prescribed range to inside the prescribed range, and the number of times the fluctuation value has changed from inside the prescribed range to outside the prescribed range within a counting period. In FIG. 16, T1 represents the counting period. In FIG. 16, the position at which the fluctuation amount has changed from outside the prescribed range to inside the prescribed range, and the position at which the fluctuation amount has changed from inside the prescribed range to outside the prescribed range are highlighted with circles. The convergence count is the number of circles in FIG. 16.

The convergence count may include a case in which the fluctuation value has reached the limit value of the prescribed range from outside the prescribed range and has then changed to outside the prescribed range. The convergence count may include a case in which the fluctuation value has reached the limit value of the prescribed range from inside the prescribed range and has then changed to inside the prescribed range.

FIG. 17 is the same graph as the progression of the fluctuation amount shown in FIG. 8. In other words, the fluctuation amount shown in FIG. 17 represents an example of the progression of the fluctuation amount when there is looseness in the fastening between the wheel and the hub. In FIG. 17, the prescribed range is set, as in FIG. 16. In FIG. 17, the position at which the fluctuation amount has changed from outside the prescribed range to inside the prescribed range, and the position at which the fluctuation amount has changed from inside the prescribed range to outside the prescribed range are highlighted with circles, as in FIG. 16.

As can be seen from the comparison between FIG. 16 and FIG. 17, the convergence count in FIG. 17 is less than the convergence count in FIG. 16. This indicates that the convergence count is less when there is looseness in the fastening between the wheel and the hub than when there is no looseness.

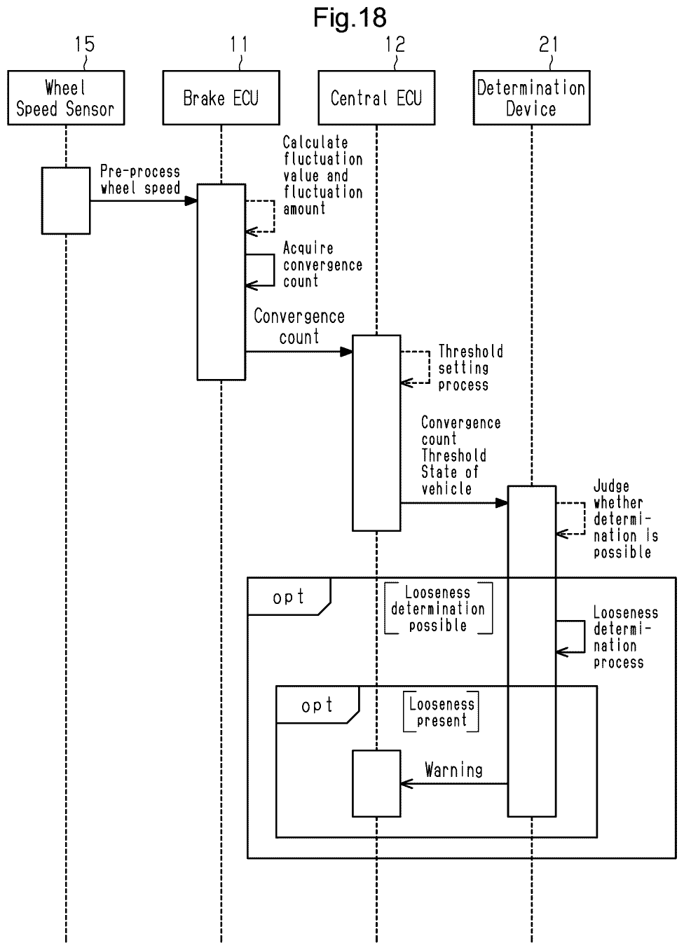

FIG. 18 shows a manner of communication in a determination system 100 according to a fourth modification, which performed among the brake ECU 11, the central ECU 12, the wheel speed sensor 15, and the determination device 21. In FIG. 18, the processes executed by the central ECU 12 are executed by the processing circuitry 13. In FIG. 18, the processes executed by the determination device 21 are executed by the processing circuitry 22. In the determination system 100 of the fourth modification, the determination device 21 determines whether there is looseness in the fastening between the wheel and the hub based on the convergence count.

As shown in the upper section of FIG. 18, the wheel speed sensor 15 transmits the pre-process wheel speed to the brake ECU 11 in the determination system 100 of the fourth modification. The brake ECU 11, upon receiving the pre-process wheel speed, calculates a fluctuation value and a fluctuation amount from the received pre-process wheel speed. In the determination system 100 of the fourth modification, when the prescribed range is set for the fluctuation value, it is not necessary to calculate the fluctuation amount.

As shown in the upper section of FIG. 18, the brake ECU 11, upon calculating the fluctuation value and the fluctuation amount, calculates the convergence count in the counting period. The brake ECU 11, upon calculating the convergence count, transmits the convergence count to the central ECU 12.

As shown in the middle section of FIG. 18, the central ECU 12, upon receiving the convergence count, executes the threshold setting process. The manner in which the central ECU 12 executes the threshold setting process is the same as the manner described in FIG. 2. That is, the central ECU 12 stores a reference threshold, for example, in the storage device 14 in advance. In the threshold setting process, the central ECU 12 sets the threshold by adjusting the reference threshold stored in the storage device 14 based on the characteristics of the vehicle 10. Instead of storing a reference threshold in the storage device 14 in advance, the central ECU 12 may calculate a reference threshold based on the history of the past convergence count in the vehicle 10.

As shown in the middle section of FIG. 18, the central ECU 12, upon setting the threshold, transmits the convergence count, the threshold, and information indicating the state of the vehicle 10. The information indicating the state of the vehicle 10 is the same as that shown in the middle section of FIG. 2. In this manner, the information transmission device 28 calculates the convergence count. The information transmission device 28 transmits the calculated convergence count to the determination device 21.

As shown in the lower section of FIG. 18, upon receiving the convergence count, the threshold, and the information indicating the state of the vehicle 10 from the central ECU 12, the determination device 21 judges whether it is possible to determine whether there is looseness in the fastening between the wheel and the hub. The manner in which the determination device 21 judges whether the determination is possible is the same as the manner shown in the lower section of FIG. 2.

As shown in the lower section of FIG. 18, when judging that it is possible to determine whether there is looseness in the fastening between the wheel and the hub, the determination device 21 executes a looseness determination process. In the looseness determination process, the determination device 21 compares the convergence count received in the middle section of FIG. 18 with the threshold.

As described above, the convergence count is less when there is looseness in the fastening between the wheel and the hub than when there is no looseness. Therefore, the determination device 21 determines that there is looseness in the fastening between the wheel and the hub when the convergence count is less than the convergence count in the normal state. When the convergence count is less than or equal to the threshold, the determination device 21 determines that there is looseness in the fastening between the hub and the wheel at which the pre-process wheel speed used for the calculation of the convergence count was detected. In this manner, the determination device 21 determines whether the convergence count is less than the convergence count in the normal state by comparing the received convergence count with the threshold.

As shown in the lower section of FIG. 18, when the determination device 21 determines that there is looseness in the fastening between any of the wheels and the corresponding hub of the vehicle 10, the determination device 21 transmits a warning to the central ECU 12. The manner in which the determination device 21 transmits the warning is the same as the manner shown in the lower section of FIG. 2.

In this manner, the determination device 21 determines whether there is looseness in the fastening between the wheel and the hub based on the convergence count in the determination system 100 of the fourth modification.

The determination device 21 determines whether there is looseness in the fastening between the wheel and the hub based on the convergence count obtained by combining the number of times the fluctuation value has changed from outside the prescribed range centering around zero to inside the prescribed range, and the number of times the fluctuation value has changed from inside the prescribed range to outside the prescribed range within the counting period. When there is looseness, the fluctuation value is unlikely to converge to a value close to zero. Accordingly, when there is looseness, the convergence count is less than that when there is no looseness. Therefore, the determination device 21 determines whether there is looseness based on the convergence count.

The determination device 21 determines that there is looseness in the fastening between the wheel and the hub when the convergence count is less than or equal to the threshold. The determination device 21 detects that the looseness is increasing based on the fact that the convergence count is less than the convergence count at the normal time. As a result, the determination device 21 is capable of detecting the occurrence of looseness.

The information transmission device 28 calculates the convergence count that is the sum of the number of times the fluctuation value has changed from outside the prescribed range centered around zero to inside the prescribed range, and the number of times the fluctuation value has changed from inside the prescribed range to outside the prescribed range within the counting period. The information transmission device 28 transmits the calculated convergence count to the determination device 21.

Thus, the information transmission device 28 causes the determination device 21 to determine whether there is an anomaly in the wheel based on the convergence count.

In the fourth modification, the central ECU 12 executes the threshold setting process as described with reference to the middle section of FIG. 18. In the threshold setting process, the central ECU 12 sets the threshold by adjusting the reference threshold. The central ECU 12 may set the threshold based on the history of the past convergence counts at the wheel for which the determination is performed.

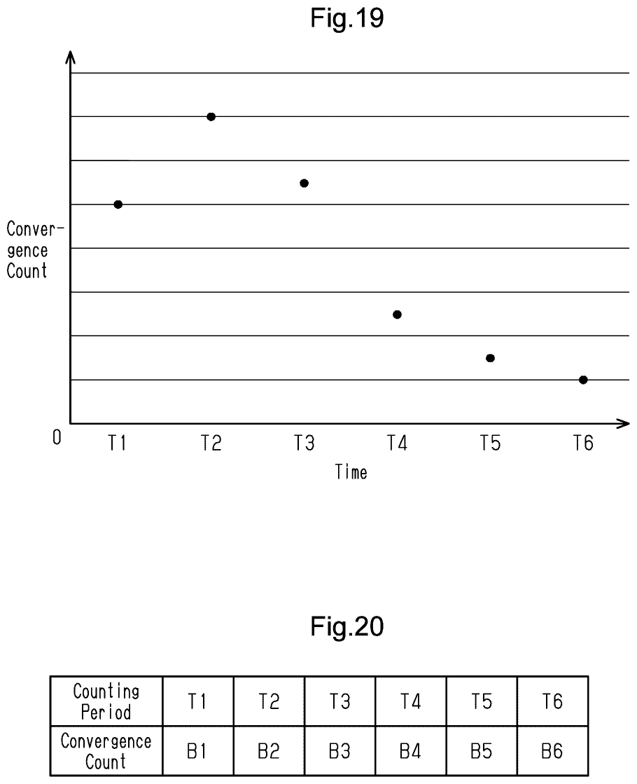

FIG. 19 illustrates an example of the progression of the convergence count acquired in the determination system 100. In the convergence count shown in FIGS. 19, T1, T2, T3, T4, T5, and T6 indicate counting periods.

The progression of the convergence count shown in FIG. 19 is calculated from, for example, the pre-process wheel speed detected at the FR wheel 17. In FIG. 19, the looseness in the fastening between the FR wheel 17 and the FR hub 24 starts increasing in the middle of the period T4.

As shown in FIG. 19, the convergence count at the FR wheel 17 rapidly decreases from the period T4. The convergence count at the FR wheel 17 gradually decreases after the period T4. In this manner, the convergence count at a wheel decreases as looseness between the wheel and the hub increases from the time at which the looseness occurs.

As described above, when the convergence count acquired at a wheel for which the determination is performed is less than a past convergence count at that wheel, the determination device 21 determines that there is looseness between the wheel and the hub.

FIG. 20 shows data stored in the storage device 14 of the determination system 100 according to a fifth modification. The data is used by the central ECU 12 to set a threshold. As shown in FIG. 20, the central ECU 12 stores, in the storage device 14, the convergence counts within the counting periods at the wheel for which the determination is performed. In FIG. 20, the convergence count in the time period TA in FIG. 19 is B1. In FIG. 20, the convergence counts calculated in the respective counting periods in FIG. 19 are represented by signs B1, B2, and B3. In the determination system 100 of the fifth modification, when performing the determination for each of the FR wheel 17, the FL wheel 18, the RR wheel 19, and the RL wheel 20, the central ECU 12 stores the convergence count for each wheel.

As described with reference to the upper section of FIG. 18, the brake ECU 11 transmits the obtained convergence count to the central ECU 12. The central ECU 12 sets the threshold by using a moving average of the convergence counts. The central ECU 12 stores the newest three of the convergence counts received from the brake ECU 11. The central ECU 12 then sets the threshold based on the three stored convergence counts. For example, the central ECU 12 may set the threshold to be less than the average of the three stored convergence counts.

Hereinafter, an example will be described. A case will now be discussed in which the central ECU 12 receives the convergence count in the period T4 from the brake ECU 11 when the convergence counts in the periods T1, T2, and T3, shown in FIG. 20, are already stored. At this time, the central ECU 12 sets the threshold to a value less than the average of B1, B2, and B3 in FIG. 20 in the threshold setting process shown in FIG. 18. Thereafter, the central ECU 12 discards the convergence count B1 in the period T1, and newly stores the convergence count B4 in the period T4 in the storage device 14. In this manner, the central ECU 12 sets the threshold based on the stored convergence counts, while updating the convergence counts stored in the storage device 14.

The number of convergence counts stored in the central ECU 12 is not limited to the number described in the fifth modification. The manner in which the central ECU 12 sets the threshold based on the past convergence counts is not limited to the manner in which the threshold is set to a value less than the average of the stored convergence counts.

In the fifth modification, the central ECU 12 sets the threshold. As in the first modification, the threshold may be set by the determination device 21. In this case, the determination device 21 sets the threshold based on the convergence counts stored in the storage device 23.

In this manner, the determination device 21 determines whether there is looseness in the fastening between the wheel and the hub for which the determination is performed by using the threshold set based on the past convergence counts at that wheel.

In this case, the determination device 21 uses, as the threshold, a value set based on the past convergence counts at the wheel, for which the determination is performed. As the looseness increases, the convergence count decreases. The determination device 21 detects that the looseness is increasing based on the data obtained from the wheel for which the determination is performed. As a result, the determination device 21 detects the occurrence of the looseness in the fastening between the wheel and the hub.

In the fourth modification, the central ECU 12 executes the threshold setting process, as described with reference to the middle section of FIG. 18. The central ECU 12 may set the threshold based on the convergence count at a wheel for which the determination is not performed, among the multiple wheels of the vehicle 10.

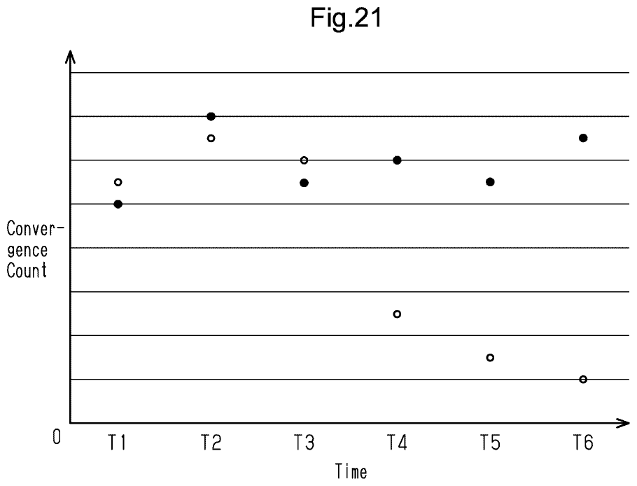

FIG. 21 illustrates an example of the progression of the convergence count acquired in the determination system 100. In the convergence count shown in FIGS. 21, T1, T2, T3, T4, T5, and T6 indicate counting periods.

FIG. 21 shows the convergence counts at the FR wheel 17 and the FL wheel 18 of the vehicle 10. In FIG. 21, open circles indicate the convergence counts at the FR wheel 17. In FIG. 21, filled circles indicate the convergence counts at the FL wheel 18. In FIG. 21, the looseness in the fastening between the FR wheel 17 and the FR hub 24 starts increasing in the middle of the period T4, as in the case shown in FIG. 19.

The convergence count of the FR wheel 17 before the period T4 is not significantly different from the convergence count at the FL wheel 18 in the same time period. As described above, the factors that affect the pre-process wheel speed include a factor that uniformly affects the pre-process wheel speeds of all the wheels of the vehicle 10. Therefore, while there is no factor affecting the pre-process wheel speed of a specific wheel in the vehicle 10, the convergence count at the FR wheel 17 is substantially the same as the convergence counts at the other wheels in the same time period.

As shown in FIG. 21, the convergence count at the FR wheel 17 decreases after the period T4. The convergence count at the FR wheel 17 after the time period T4 is less than the convergence count at the FL wheel 18 in the same time period. In this manner, when one of the multiple wheels of the same vehicle is loosened from the hub, the convergence count of the loosened wheel is less than the convergence counts at the other wheels.

When the convergence count acquired at the wheel for which the determination is performed is less than the convergence counts at other wheels in the same time period, the determination device 21 determines that there is looseness in the fastening between the wheel for which the determination is performed and the hub.

The determination system 100 according to a sixth modification performs the processes described below.

In the determination system 100 of the sixth modification, the central ECU 12 acquires the convergence counts at the FR wheel 17, the FL wheel 18, the RR wheel 19, and the RL wheel 20 in the same time period. As described with reference to the upper section of FIG. 18, the brake ECU 11 transmits the calculated convergence count to the central ECU 12. In the sixth modification, the central ECU 12 starts the execution of the threshold setting process when the central ECU 12 acquires all the convergence counts at the FR wheel 17, the FL wheel 18, the RR wheel 19, and the RL wheel 20 in the same time period.

In the threshold setting process, the central ECU 12 calculates the average of the convergence counts in the same time period at the wheels for which the determination is not performed, among the multiple wheels of the vehicle 10. For example, when setting the threshold used in the determination for the FR wheel 17, the central ECU 12 calculates an average value of the convergence counts at the FL wheel 18, the RR wheel 19, and the RL wheel 20 in the same time period. Then, the central ECU 12 sets the threshold based on the calculated average value. For example, the central ECU 12 sets the threshold corresponding to the FR wheel 17 to a value less than the calculated average value.

The manner in which the central ECU 12 sets the threshold based on the convergence counts at the wheels for which the determination is not performed among the multiple wheels of the vehicle 10 is not limited to the manner according to the sixth modification. For example, the central ECU 12 may set the threshold corresponding to the FR wheel 17 to a value less than the convergence count at the FL wheel 18 in the same time period.

In the sixth modification, the central ECU 12 sets the threshold. As in the first modification, the threshold may be set by the determination device 21. In this case, the determination device 21 acquires information on the convergence counts at the wheels from the brake ECU 11.

In this manner, the determination device 21 determines whether there is looseness in the fastening between any of the wheels and the hub by using the threshold that is set based on the convergence counts in the same time period at the wheels for which the determination is not performed, among the wheels of the vehicle 10.

In this case, the determination device 21 uses, as the threshold, a value set based on the convergence counts in the same time period at wheels for which the determination is not performed among the multiple wheels of the vehicle 10.

When any one of the multiple wheels is loosened from the hub, the convergence count at the loosened wheel is less than the convergence counts at the other wheels. The factors that affect the pre-process wheel speed include a factor that uniformly affects the pre-process wheel speeds of all the wheels of the vehicle, like a change in the road surface condition. The determination device 21 determines whether there is looseness by comparing the convergence counts at the wheels of the same vehicle. The determination device 21 thus suppresses the occurrence of erroneous determination due to a factor that uniformly affects the pre-process wheel speeds of all the wheels.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A determination device, comprising processing circuitry, wherein the processing circuitry is configured to:
acquire fluctuation data indicating a progression of a fluctuation value that is a difference between a pre-process wheel speed detected by a wheel speed sensor that detects a rotation speed of a wheel of a vehicle and a post-process wheel speed obtained by performing a low-pass filter process on the pre-process wheel speed; and
determine whether there is an anomaly in the wheel based on the fluctuation data.

2. The determination device according to claim 1, wherein the anomaly in the wheel includes looseness in fastening between the wheel and a hub.

3. The determination device according to claim 2, wherein the fluctuation data includes a time-integrated value over a prescribed period of a fluctuation amount, the fluctuation amount being an absolute value of the fluctuation value.

4. The determination device according to claim 3, wherein
an upper limit value is set for the fluctuation amount, and
the time-integrated value is calculated using the fluctuation amount that is limited by the upper limit value so as not to exceed the upper limit value.

5. The determination device according to claim 3, wherein
the fluctuation data includes a gradient of a progression of a cumulative total of the time-integrated value in a calculation period, the calculation period being longer than the prescribed period, and
the gradient is calculated using multiple time-integrated values calculated in the calculation period.

6. The determination device according to claim 5, wherein the processing circuitry is configured to determine that there is looseness in the fastening between the wheel and the hub when the gradient is greater than or equal to a threshold.

7. The determination device according to claim 6, wherein the threshold is set based on the gradient in the past of the wheel for which a determination is performed.

8. The determination device according to claim 6, wherein
the wheel includes a wheel for which a determination is performed and a wheel for which the determination is not performed,
the threshold is set based on the gradient of the wheel for which the determination is not determined, and
the gradient used for setting the threshold is acquired in a same time period as a time period in which the gradient of the wheel for which the determination is performed is acquired.

9. The determination device according to claim 2, wherein the fluctuation data includes a convergence count that is a sum of a number of times the fluctuation value has changed from outside a prescribed range centered around zero to inside the prescribed range, and a number of times the fluctuation value has changed from inside the prescribed range to outside the prescribed range within a counting period.

10. The determination device according to claim 9, wherein the processing circuitry is configured to determine that there is looseness in fastening between the wheel and the hub when the convergence count is less than or equal to a threshold.

11. The determination device according to claim 10, wherein the threshold is set based on the convergence count in the past of the wheel for which a determination is performed.

12. The determination device according to claim 10, wherein
the wheel includes a wheel for which a determination is performed and a wheel for which the determination is not performed,
the threshold is set based on the convergence count at the wheel for which the determination is not determined, and
the convergence count used for setting the threshold is acquired in a same time period as a time period in which the convergence count at the wheel for which the determination is performed is acquired.

13. The determination device according to claim 1, wherein
the processing circuitry is configured not to use, for a determination of whether there is an anomaly in the wheel, the fluctuation data based on the pre-process wheel speed detected when a state of the vehicle is a specific state, and
the specific state includes at least one of
a state in which an antilock brake system of the vehicle is activated,
a state in which a traction control system of the vehicle is activated,
a state in which a vehicle stability control system of the vehicle is activated, and
a state in which the vehicle is traveling on rough terrain.

14. The determination device according to claim 1, wherein
the vehicle includes an electronic control unit directly connected to the wheel speed sensor via a communication line, and
the processing circuitry is configured to determine whether there is an anomaly in the wheel based on the fluctuation data calculated by the electronic control unit.

15. An information transmission device, comprising processing circuitry, wherein the processing circuitry is configured to:
acquire a pre-process wheel speed detected by a wheel speed sensor that detects a rotation speed of a wheel of a vehicle;
acquire a post-process wheel speed by performing low-pass filter process on the pre-process wheel speed;
calculate a fluctuation value that is a difference between the pre-process wheel speed and the post-process wheel speed; and
transmit fluctuation data indicating a progression of the fluctuation value to the determination device according to claim 1.

16. The information transmission device according to claim 15, wherein the processing circuitry is configured to:
periodically calculate a time-integrated value over a prescribed period of a fluctuation amount, the fluctuation amount being an absolute value of the fluctuation value;
calculate a gradient of a progression of a cumulative total of the time-integrated value in a calculation period using multiple time-integrated values calculated in the calculation period, the calculation period being longer than the prescribed period; and
transmit the gradient to the determination device as the fluctuation data.

17. The information transmission device according to claim 15, wherein the processing circuitry is configured to:
calculate a convergence count that is a sum of a number of times the fluctuation value has changed from outside a prescribed range centered around zero to inside the prescribed range, and a number of times the fluctuation value has changed from inside the prescribed range to outside the prescribed range within a counting period; and
transmit the convergence count to the determination device as the fluctuation data.

18. A determination system, comprising an information transmission device and a determination device, wherein the information transmission device is configured to:
acquire a pre-process wheel speed detected by a wheel speed sensor that detects a rotation speed of a wheel of a vehicle;
acquire a post-process wheel speed by performing low-pass filter process on the pre-process wheel speed;
calculate a fluctuation value that is a difference between the pre-process wheel speed and the post-process wheel speed; and
transmit fluctuation data indicating a progression of the fluctuation value to the determination device, and
the determination device is configured to:
determine whether there is an anomaly in the wheel based on the fluctuation data; and
when determining that there is an anomaly in the wheel, notify a user of the vehicle of the anomaly in the wheel.

19. The determination system according to claim 18, wherein the anomaly in the wheel includes looseness in fastening between the wheel and a hub.
